(19) United States
(12) Patent Application Publication
(10) Pub. No.: US 2010/0309290 A1
(43) Pub. Date: Dec. 9, 2010

(54) SYSTEM FOR CAPTURE AND DISPLAY OF STEREOSCOPIC CONTENT

(76) Inventor: Stephen Brooks Myers, Shreve, OH (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/796,660

(22) Filed: Jun. 8, 2010

Related U.S. Application Data
(60) Provisional application No. 61/184,889, filed on Jun. 8, 2009.

(51) Int. Cl. H04N 13/02

(52) U.S. Cl. 348/46; 348/E13.074

(57) ABSTRACT

A system for providing capture and display of stereoscopic content with interchangeable portable devices, the system including a portable transmitter/receiver device configured to communicate stereoscopic content between a first device where an image originates and a second device through which a user may view the stereoscopic content, wherein the portable transmitter/receiver device is configured to communicate through wired and/or wireless communication.

### CROSS-REFERENCE TO RELATED APPLICATIONS

This application claims the benefit of U.S. Provisional Application No. 61/184,889 filed Jun. 8, 2009, and incorporated herein by reference in its entirety.

### BACKGROUND OF THE INVENTION

Embodiments of the present invention relate to a system for providing capture and display of stereoscopic content with portable devices.

With the advent of webcams, digital cameras, and flat screen viewers, the prospect of using stereoscopic images with video conferencing, displaying video media and the like is slowly becoming realized. However, technology to provide stereoscopic images (three-dimensional images) is cumbersome and not easily transportable by a single individual. Furthermore, such systems are complete systems, meaning that elements are not interchangeable where different brands of certain components may not work with other brands of other components.

Individuals desiring to broadcast and watch various forms of images, still and moving, in three-dimensional would benefit from a method and system that allows for portable devices to be used in building such a system. Furthermore, enabling interoperability between all 3D capable display and capture devices, whether portable or stationary, would be beneficial to build a more capable/applicable system of this type.

### BRIEF DESCRIPTION OF THE INVENTION

A system for providing capture and display of stereoscopic content with interchangeable portable devices is disclosed. The system comprises a portable transmitter/receiver device configured to communicate stereoscopic content between a first device where an image originates and a second device through which a user may view the stereoscopic content. The portable transmitter/receiver device is configured to communicate through wired and/or wireless communication.

In another exemplary embodiment the system comprises an initiating device for capturing content to be converted to stereoscopic content and/or already possess stereoscopic content, a display device to view stereoscopic content, and a portable transmitter/receiver device configured to receive data from the initiating device, convert any content that is not stereoscopic content into stereoscopic content, and communicate the stereoscopic content for viewing with the display. The portable transmitter/receiver device is configured to communicate through wired and/or wireless communication with the initiating device and the display device.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 depicts a block diagram illustrating an exemplary embodiment of the stereoscopic capture and display system;

FIG. 2 depicts a more detailed block diagram illustrating a plurality of exemplary subsystems that may be used to provide portable and stationary three-dimensional capable I/O devices to enable three-dimensional content to be captured and displayed from both remote and physical signals by linking like devices; and

FIG. 3 depicts a more detailed block diagram illustrating a plurality of exemplary subsystems that may be used to provide portable and stationary three-dimensional capabilities using a mobile device.

### DETAILED DESCRIPTION OF THE INVENTION

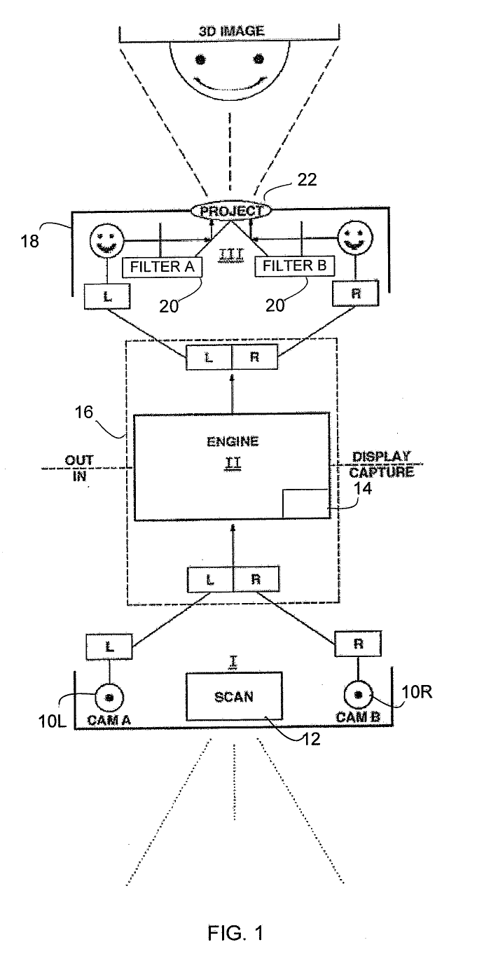

FIG. 1 depicts a block diagram illustrating an exemplary embodiment of a stereoscopic capture and display system. Three primary units or elements are illustrated. A first element is the stereo camera 10. In an exemplary embodiment at least two cameras 10L, 10R are used, where a first camera 10L captures an image from a left view and a second camera 10R captures an image from a right view. Though not necessarily required, in an exemplary embodiment, a scan subsystem 12 is used to cast a pattern on an object being visually captured to assist the cameras with capturing depth perception and shape data. Preferably, the pattern is only visible to the cameras' lenses. For example, such an invisible pattern may be provided using infrared technology.

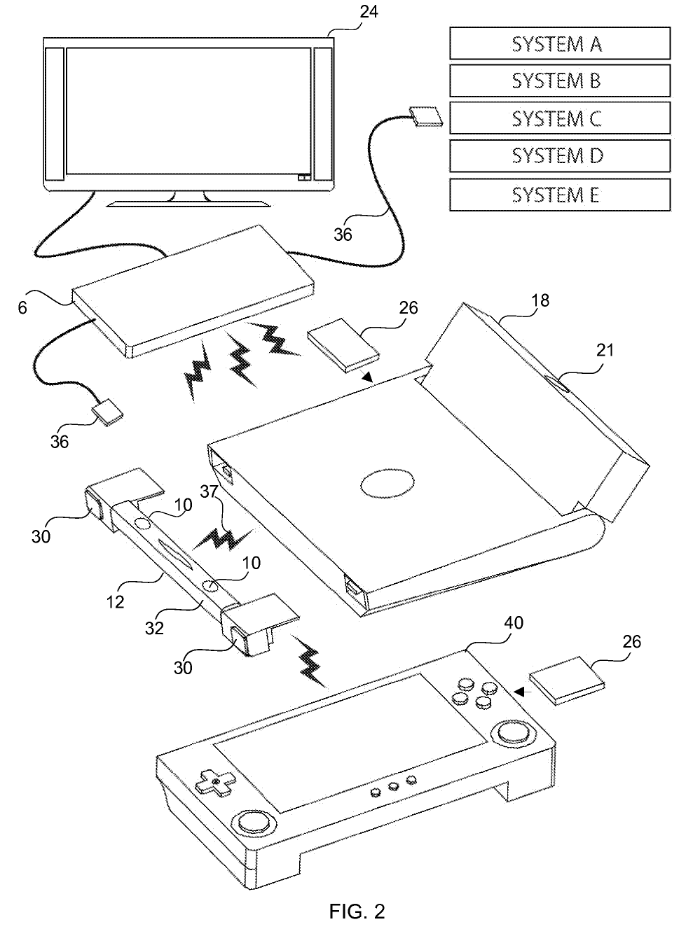

When a single element, and as explained in further detail below, the stereo camera 10 may also possess a processor 14, illustrated in FIG. 2, that is capable of combining the left image with the right image and wirelessly transmit the combined image, and other combined information to another primary unit. The primary unit as used herein may refer to any of the other components that are disclosed in this document. The processor 14 is also capable of receiving combined information from other primary units. In another exemplary embodiment, the processor 14 is provided in an engine unit 16, as discussed below in further detail. The stereo camera 10 may also have microphones (not illustrated), at least two, to record audio in stereo and speakers to output recorded audio in stereo.

A second element is the engine unit 16. The engine 16 is a processing, graphics, and/or storage unit which combines, transmits, and/or receives and separates any and all of the stereo information into pairs. The purpose of the engine 16 is to process and/or store the captured information for eventual displaying. Processing may be accomplished through software and/or hardware. Therefore, those skilled in the art will readily recognize that the engine 16 may range from a processor to a single computer chip dedicated as a stereo coder/decoder having the ability to transmit and/or receive, or minimally to provide and/or receive information. The engine 16 is also able to process the recorded audio.

A third element is a stereo projector 18. The stereo projector 18 receives and displays the final image information in three dimensions. The separated stereo pair of images are filtered internally by passing the images through respective filters 20 and then projected out of a single lens 22 and/or display. The filters 20 may be colored and/or polarized filters. Those skilled in the art will readily recognize that other filtration processes may be used. For example, the filtration process can be made to work with any display system, as well as with a projection system. For example, red/blue software filters, implemented through software, may be used on such displays as, but not limited to, light emitting diode (“LED”), liquid crystal display (“LCD”), Plasma, cathode ray tube (“CRT”), etc. Other exemplary filters include, but are not limited to, Dolby®, horizontal polarization, circular polarization, etc. The stereo projector 18 may comprise more than one type of filter, where the multiple filters are swappable depending on the image received or by selection of an operator. Though discussed further below, the filters may be software filters and/or physical films.

As illustrated, after the left image is filtered through its respective filter 20A, and the right image is filtered through its respective filter 20B, the images are combined again, such as with mirrors, prior to being emitted from the projector lens and/or display. In a similar fashion, the stereo sound may be emitted from the stereo projector 18. With non-projection systems the images may be combined, after filtering, for display on a single display system.

In use, the engine 16 can be integrated within a handheld device, such as but not limited to, a cell phone. A cell phone may possess two cameras to capture the left and right image, or two cell phone cameras may be used. The images from the two cameras 10 are supplied to the engine 16, which since it is within a cell phone is a microchip. The engine 16 processes the images for feeding into the projector 18. The projector 18 may be a component external to the camera 10.

When two cell phones are used, each with its own camera, the cell phones may be configured to communicate with each other to ensure that each is at an acceptable angle for taking a left field picture and a right field picture. For example, BlueTooth®, Infrared, or some other communication technique may be used to allow each camera 10A, 10B to know its position with respect to the other camera.

Each of these elements may be separated and used individually. The engine 16, when alone may be used with an existing external player or system (Systems A-E as illustrated in FIG. 2), such as, but not limited to, players with a Blu-Ray®, video home system (“VHS”), digital video disc (“DVD”), etc., format, to play a media containing a stereopair in three dimensions. Additionally, each element is small enough to be mobile and/or utilized with mobile devices. Meaning, a single user can move each element. Furthermore, the projector 18 and camera 10 may communicate with the engine 16 through either wired and/or wireless communication.

FIG. 2 depicts a more detailed block diagram illustrating a plurality of exemplary subsystems that may be used to provide portable and stationary three-dimensional capable I/O devices to enable three-dimensional content to be captured and displayed from both remote and physical signals by linking like devices. A display 24, such as, but not limited to, a flat panel TV, is provided. Those skilled in the art will readily recognize that all types of displays, such as computer monitors, projectors, tablets, etc., may be used. Thus, the display 24 could be High Definition, three-dimensional, or even a standard tube, but is ultimately created around and meant for full interaction in stereoscopic three-dimensional (“S3D”). Most modern display panels have advanced features such as wired and wireless connections for enhanced capabilities and exemplary embodiments of this invention may make use of such features and connections.

A portable projector device 18 or pico projector is also disclosed. The portable projector device 18 may also be considered a display since its function is to provide a display of the stereoscopic content. This could be a device in and of itself, or a casing device to hold a portable device such as a pico projector, cellular phone, touch screen, eyewear, etc., to enable it as part of an S3D system. It should be understood that the projection display 21 in this portable device 18 is capable of outputting S3D images. Components encased within this housing are fully able to receive and output S3D content through various techniques. The portable projector 18 has various input options and connections as to create a portable platform for projecting a number of user-selectable sources in S3D. A removable cartridge 26 comprising components for enhanced capabilities to the portable projector 18 in reference to memory, graphics, software, content, connectivity, etc., is also provided.

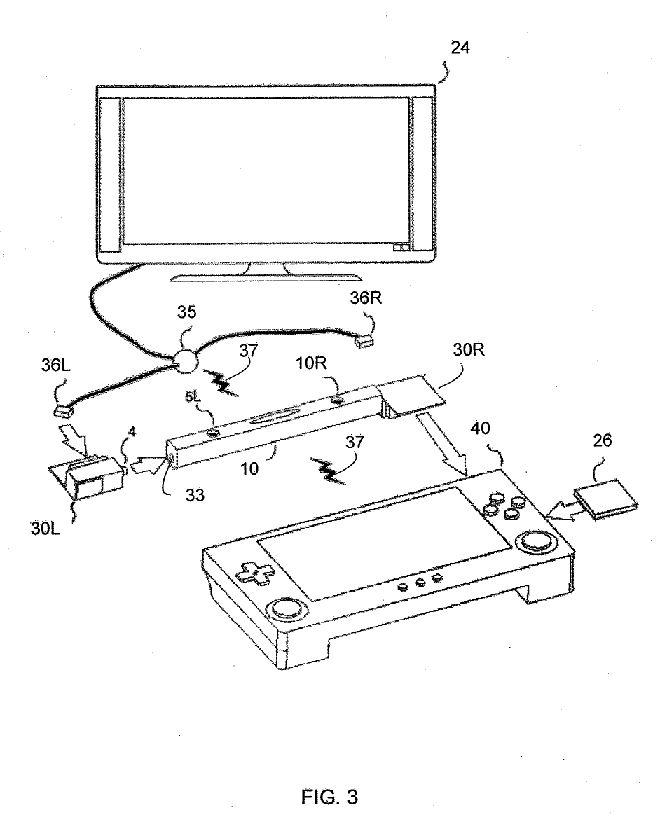

Detachable and/or hot-swappable modules 30 are provided. The modules 30 connect and disconnect from the projector housing 18 and various components such as the stereo camera 10, and/or a mobile device 40 (as further illustrated in FIG. 3). Two modules 30L and 30R are illustrated, which connect to the mobile projector housing 18 through a physical/electrical link allowing information, power, etc., to be transmitted between the modules 30 and projector 18. Examples of wired connections include, but are not limited to, mini-high-definition multimedia interface (HDMI) or similar Audio Video (AV) connector standards. When the modules 30 are connected, all components work as a singular upgraded device, or are integrated, and they may or may not need to be physically connected to enable various capabilities of the devices separately. These modules may contain mechanical or electrical components, battery, memory, software, input/output, speakers/microphone, camera, etc.

As disclosed above, a stereo camera subsystem 32 may comprise two cameras 10L, 10R. The stereo camera subsystem, and/or individual cameras may be considered an initiating device since capture of content begins with these devices. Though individual cameras 10 may be used, in another exemplary embodiment, a single unit 32 may house both cameras. It should be understood that the camera subsystem 32 houses multiple components which enable it to work as a standalone unit or when physically attached to the modules 30 and a mobile device 40, disclosed in further detail below (and in FIG. 3).

As further illustrated in FIG. 3, a connector port 33 on each end of the camera subsystem 32 allows information, power, etc., to be transmitted between the camera subsystem 32 and the modules 30 physically connected to it by way of a reception port 31. In this illustration it should also be understood that the camera subsystem 32 is rotatable at least 180 degrees while maintaining full capabilities. This means the user interfacing with the portable projector 18 can point the camera subsystem 32 directly at himself for certain applications or away from himself at various angles to allow other uses.

A transmitter/receiver 35 is further disclosed. The transmitter/receiver 35 is in essence the engine 16 disclosed above. The transmitter/receiver 35 has both ‘wired 36L and 36R connections and ‘wireless 37 communication connections to the stereoscopic camera subsystem 32 and/or the portable projector 18. The transmitter/receiver 35 may be connected to the display 24 through an HDMI cable (or other known able wired connectivity techniques), and has a wireless home digital interface and/or wireless high definition interface (WHDI, WIHD, etc.) receiver as well as physical connectors for modules or other compatible devices. For example, wireless transmissions 37 may be made between the transmitter/receiver 35 and the portable projector 18, as well as the transmitter/receiver 35 and the camera system 32. This enables the transmission of stereo visuals and sound to be sent from the display 24 to the stereo camera subsystem 32 and the portable projector 18. The opposite transmission works equally as well as stereo visuals and sound are sent from the stereo camera subsystem 32 and portable projector 18 to the display 24 through the transmitter/receiver 35.

The transmitter/receiver 35 has S3D information passing through it (to and from both wired and wireless sources) and may store/buffer this information and time its delivery accordingly to enable receiving devices to tune into and process S3D information in real time. Those skilled in the art would recognize that the components comprising the transmitter/receiver 35, which make it able to properly operate, may also be embedded into any one of the other devices, subsystems, components, etc., and/or added as an aftermarket part to a device such as the portable 3D (pico) projector. For example, the transmitter/receiver 35 may be integrated into the cartridge 26 disclosed above.

Thus, the transmitter/receiver 35 is able to digitize (capture) and transmit (display) through any one of a plurality of signals, wired and/or wireless. The transmitter/receiver is further able to alter the three-dimensional content by passing it through a plurality of filters (for modularity, the filters may be software-based), wherein the three-dimensional content is transmitted through a plurality of signals, received by a plurality of compatible components, and decoded by a plurality of processors between various components and systems that are capable of capture and display (I/O) of three-dimensional content. The transmitter/receiver 35 in essence performs the functions discussed above with respects to the engine 16.

A mobile device 40 is further displayed. This could be a mobile device in and of itself, or a casing 42 to hold the mobile device 40. Exemplary examples of the mobile device include, but are not limited to, a cellular phone, and hand-held gaming system. It should be understood that the display in the mobile device 40 might be made capable of outputting S3D. If a phone or similar mobile device 40 is encased within the housing 42, a filter 44 covering the screen area may enable S3D. The mobile device 40 may further have various input/output options and connections such as 3/4G that may be used to extend the modular platform for user-applicable capabilities and S3D applications. As explained below, the mobile device 40 may also be an initiating device since content, usually stereoscopic content, may initiate from a particular mobile device, or one of the Systems A-E.

As referenced above, a removable cartridge 26 is disclosed. Removable cartridges 26 may be used to upgrade any component, such as but not limited to, the projector 18 and/or the mobile device 40, or other compatible system or devices in reference to memory, graphics, software, content, connectivity, etc. This cartridge 26 may be a standard, such as but not limited to, an SD Flash memory, SDHC, Micro SDHC, Eye-Fi, or similar style removable cartridge or it may be a proprietary cartridge. Its use and ability may vary, as described above, but it could enable various devices to tap into and connect with the invention and patented system and method for capture and display of stereoscopic content.

Other external elements, systems, or components may be connected. For the intent of this document, these other external elements may also be referred to as mobile hand-held devices. As an example, a home entertainment system, or similar content delivery systems, such as but not limited to, a game (System A), Blu-Ray® disc player (System B), digital cable or satellite box (System C), Internet or network device (System D), computer (System E), etc., may be connected to a display 24. Systems A-E could also represent other mobile devices, such as but not limited to, a phone, hand-held gaming device, etc. Because mobile devices are also capable of capturing and displaying such 3D content, such devices are also enabled to send and receive a physical (wired) or wireless (radio, electronic) transmission of the same content to and from various wired or wireless sources. More specifically, the three-dimensional content may be provided from one of the Systems A-E or may be sent to one of the Systems A-E. Thus, since many three-dimensional display systems and content players may be interoperable, various three-dimensional systems are able to communicate to and from, agnostic of stereoscopic content creation or playback methodologies.

Additionally, though eye glasses with specific filters are typically worn by a user to fully experience the stereoscopic effects, a type of display 24 may used a particular material wherein wearing such glasses is not required. The exemplary embodiments of the invention disclosed herein is usable with any one of any various displays, agnostic of any specific display's enabling technologies. Exemplary embodiments of the invention are also applicable when glasses are worn.

Though the communication is illustrated as being a wired connection in FIG. 2, the communication can also be wireless. Furthermore, the communication may take place over great distances, ranging from within a same room to different cities. Because of the increased file requirements for digitizing such multi-source content, this requires an increase in transmission bandwidth. One solution to accomplish this with current technology involves dedicating a specific Mobile-to-Stationary 3-D System link and various methods are described herein as part of the present invention in which to achieve this connection.

As stereo refers to a pair, just as our eyes take in views from two separate vantage points (L&R) and our brain combines them to form depth perception, so does S3D content and requires corresponding Left & Right data. This in turn requires an increase in memory and bandwidth so as to send three-dimensional files in real time from one device to another effectively. Streaming is possible when combined channels or signals are simultaneously feeding separate corresponding views to a receiving display and processed in sync to make up the final stereoscopic pair as seen on the three-dimensional capable display.

As an example, a three-dimensional media reader/player, such as a Blu-Ray® Player, is connected to a three-dimensional TV in a living room in Los Angeles, Calif. The Blu-Ray® Players' signal is outputting the inserted disc media to the display 24 and the information on this disc is passing through a physical cable connected to the Blu-Ray® Player on one end and the display 24 on the other. The Blu-Ray® Player and/or the display 24 may inherently have some form of wireless capability built in so as to connect to a network. As the exemplary embodiments of the invention illustrates, a physical device with enhanced capabilities for capturing/displaying content or information that is being sent through a stereoscopic system, could be physically added to the stereoscopic system and would enable transmission of the content or information being played on the stereoscopic system to other remote displays beyond that of the physically connected display 24. This capability could exist within the display 24 or connected three-dimensional content players themselves, the transmitter/receiver 35, the removable cartridge 26, or in aftermarket device that would make transmission possible as described herein. It should be understood that exemplary embodiments of the invention covers a providing for a plurality of transmitters and receivers, in a plurality of wired and wireless processing devices, are able to combine to enhance capabilities and grow the overall potential of an interconnected S3D system.

In the case that multiple network connections are being made by multiple physically connected I/O devices, these network connections are able to team up and collaborate to handle the transmission of increased file sizes of S3D content being processed. In one exemplary embodiment, the transmitter/receiver 35 has the ability to store information to memory and send/receive information through at least two wired/wireless channels. These may be two like (radio) signals or two differing signals. In the illustration it is to be understood that the cable contains a Millimeter Wave wireless home digital interface (WHDI), WiFi, and/or other similarly capable means whether solo or combined. These (radio) signals combined make possible various techniques to transmit separate digital information packages containing three-dimensional content information, in combination with other relatable information (at an increased rate so as to make possible real time transmission of large three-dimensional files) to a compatible receiving display capable of processing corresponding S3D information.

In continuation to the above example of the Blu-Ray® Player in a Los Angeles living room being connected to such a transmitter/receiver 35, the three-dimensional content being sent to the display 24 (such as through a physical connection to an HDMI cable on both ends) may also be viewed on a mobile three-dimensional-capable device, at least one of System A-E. This mobile device receiving the wireless S3D transmission may be in the hands of the user watching the Blu-Ray® disc and he is seeing related content in three-dimensional or it may be remotely accessed on a three-dimensional mobile device in another geographic location entirely. Per the continued example, the first individual who is watching the Blu-Ray® disc in California invites a second individual to tune in to his transmitting channel for a geographically remote location, with a remote device, collaborative viewing of the movie being watched where both are watching the movie instantaneous (nearly at the same time). The second individual, in turn on a portable three-dimensional pico projector 18 (possibly located in a different geographic location) accesses streaming S3D content. It should be understood that exemplary embodiments of the present invention provides for transmission being possible in real time, provided that mobile systems such as the three-dimensional projector in this example are capable to receive information remotely from compatible systems. It should be understood exemplary embodiments of the invention benefit from the multi-signals outputting information packets through a plurality of channels or signals, such as but not limited to, WHDI and WiFi, though a use of multiple signals may not be necessary to achieve transmission of content when not in real time.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc., do not denote any order or importance, but rather the terms first, second, etc., are used to distinguish one element from another.

What is claimed is:

1. A system for providing capture and display of stereoscopic content with interchangeable portable devices, the system comprising a portable transmitter/receiver device configured to communicate stereoscopic content between a first device where an image originates and a second device through which a user may view the stereoscopic content, wherein the portable transmitter/receiver device is configured to communicate through wired and/or wireless communication.

2. The system according to claim 1, wherein the portable transmitter/receiver device is further configured to combine non-stereoscopic content into stereoscopic content.

3. The system according to claim 1, further comprises at least one camera configured to capture content from a left perspective and a right perspective, wherein the captured content is provided to the portable transmitter/receiver.

4. The system according to claim 3, wherein the at least one camera comprises at least two cameras, each camera comprises a determining technique to ensure that each camera is at an acceptable angle from each other for capturing an acceptable left field content and an acceptable right field content.

5. The system according to claim 1, further comprises a display device and/or a portable projector through which a stereoscopic content is displayed.

6. The system according to claim 1, further comprises a hand-held mobile device through which the stereoscopic content is displayed, from which stereoscopic content originates, and/or from which non-stereoscopic content originates which is then converted to stereoscopic content by the portable transmitter/receiver device.

7. The system according to claim 1, wherein the transmitter/receiver device is configured to communicate stereoscopic content to a remote device located geographically apart from the transmitter/receiver device.

8. The system according to claim 7, further comprises a communication technique that provides for real-time communication to the remote device so that viewing of the stereoscopic content is nearly instantaneous at both a device displaying the stereoscopic content close to the transmitter/receiver device and the remote device that is also displaying the stereoscopic content.

9. A system for providing capture and display of stereoscopic content with interchangeable portable devices, the system comprising:
an initiating device for capturing content to be converted to stereoscopic content, already possess stereoscopic content, and/or ability to capture stereoscopic content;
a display device to view stereoscopic content; and
a portable transmitter/receiver device configured to receive data from the initiating device, convert any content that is not stereoscopic content into stereoscopic content, and communicate the stereoscopic content for viewing with the display;
wherein the portable transmitter/receiver device is configured to communicate through wired and/or wireless communication with the initiating device and the display device.

10. The system according to claim 9, wherein the initiating device is at least one camera, and/or a hand-held device that has content associated with the hand-held device.

11. The system according to claim 9, wherein the display device comprises a monitor device and/or a projector device.

12. The system according to claim 9, wherein the at least one camera is configured to capture content from a left perspective and a right perspective.

13. The system according to claim 9, further comprises at least one module configured to integrate the initiating device, display, and/or transmitter/receiver device to function as a single unit.

14. The system according to claim 9, wherein the transmitter/receiver device is configured to communicate stereoscopic content to a remote device located geographically apart from the transmitter/receiver device.

15. The system according to claim 14, further comprises a communication technique that provides for real-time communication to the remote device so that viewing of the stereoscopic content is nearly instantaneous at both a device displaying the stereoscopic content close to the transmitter/receiver device and the remote device that is also displaying the stereoscopic content.
